(19) United States
(12) Patent Application Publication
(10) Pub. No.: US 2023/0169877 A1
(43) Pub. Date: Jun. 1, 2023

(54) LEARNING VIA A VIRTUAL REALITY EXPERIENCE

(71) Applicant: Librarium, Eagle, ID (US)

(72) Inventors: Duane Curtis Mathes, Eagle, ID (US); James Bering Bradbury, Eagle, ID (US)

(73) Assignee: Librarium, Eagle, ID (US)

(21) Appl. No.: 18/071,220

(22) Filed: Nov. 29, 2022

Related U.S. Application Data
(60) Provisional application No. 63/284,309, filed on Nov. 30, 2021.

(51) Int. Cl. G09B 5/06; G06T 19/00

(52) U.S. Cl. CPC G09B 5/06; G06T 19/006

(57) ABSTRACT

A method, computing system, and non-transitory computer-readable storage medium are provided. A computing system receives a selection of a room for a virtual reality experience. The computing system then presents the room as the virtual reality experience. First input, including one or more memorization items the user wants to memorize, is received by the computing system. The computing system suggests to the user at least one respective object for each of the one or more memorization items. The computing system presents to the user each of at least one respective selected object in a corresponding respective location within the room in the virtual reality experience in response to receiving a selection of one or more objects of the at least one respective object. Each of the one or more selected objects at the corresponding respective location is associated with a respective one of the one or more memorization items.

This application claims the benefit of U.S. Provisional Application No. 63/284,309, filed in the U.S. Patent and Trademark Office on Nov. 30, 2021. U.S. Provisional Application No. 63/284,309 is hereby incorporated by reference in its entirety.

### BACKGROUND OF THE INVENTION

Remote learning is a chore. There are few if any solutions for a person to truly take control of their learning or be taught better learning methodologies in a remote way. While there are a handful of learning platforms on the web, they are based on outdated learning methodologies and can be either highly application- or industry-specific or too broad to be of much use. More importantly, existing solutions are not fun to use.

### SUMMARY OF THE INVENTION

In a first embodiment, a method is provided to help a user learn and remember. A computing device receives from the user a selection of a room from among multiple rooms for a virtual reality experience. The computing device presents to the user the selected room as the virtual reality experience. First input, including one or more memorization items the user wants to memorize, is received. The computing device suggests, to the user, at least one respective object for each of the one or more memorization items. The computing device presents to the user each of at least one respective selected object in a corresponding respective location within the room in the virtual reality experience in response to receiving a selection of one or more objects of the at least one respective object, each of the one or more selected objects at the corresponding respective location being associated with a respective one of the one or more memorization items.

In a second embodiment, a computing system is provided that includes at least one processor, a memory including instructions for the at least one processor, one or more input/output devices, and a bus connecting the memory and the one or more input/output devices with the at least one processor. The instructions configure the computing device to perform multiple operations. According to the operations, a room is presented to the user as a virtual reality experience. First input, including one or more memorization items the user wants to memorize is received. At least one respective object is suggested for each of the one or more memorization items. Each of at least one respective selected object is presented in a corresponding respective location within the room in the virtual reality experience in response to receiving a selection of one or more objects of the at least one respective object. Each of the one or more selected objects at the corresponding respective location is associated with a respective one of the one or more memorization items.

A non-transitory computer-readable storage medium is provided, which has instructions stored thereon for configuring a computing device to perform multiple operations. According to the multiple operations, a room is presented to a user as a virtual reality experience. First input, including one or more memorization items the user wants to memorize is received. At least one respective object for each of the one or more memorization items is suggested. Each of at least one respective selected object is presented in a corresponding respective location within the room in the virtual reality experience in response to receiving a selection of one or more objects of the at least one respective object. Each of the one or more selected objects at the corresponding respective location is associated with a respective one of the one or more memorization items.

### BRIEF DESCRIPTION OF THE DRAWINGS

FIG. 1 shows an example environment in which embodiments may be implemented.

FIG. 2 illustrates a functional block diagram of an example computer system that may implement either a user's computing device or a server according to an embodiment.

FIG. 3 is a flowchart of an example process, according to an embodiment, in which a user selects a room as a virtual reality (VR) experience, provides first input including one or more memorization items, is presented with at least one respective object for each of the one or more memorization items, and is provided with guidance to travel along a predefined path within the room.

FIG. 4 is a flowchart of an example process, according to an embodiment, for finding a library object with a name similar to one or more words associated with a memorization item, and suggesting to the user associating the found library object with the memorization item.

FIG. 5 is a flowchart of an example process for providing support for lists of memorization items according to an embodiment.

FIG. 6 illustrates an example assessment tool that may be used to test how well a user has learned subject matter.

### DETAILED DESCRIPTION OF THE INVENTION

Embodiments consistent with this disclosure provide a virtual reality experience for a user to learn memorization items. In various embodiments, a user may select a room from among multiple rooms as a virtual reality experience. After selecting the room, the user is presented the room in a virtual reality environment. The room may include furniture, which the user may modify, as well as other items such as bookshelves, books, lamps, etc.

When the user initially enters the room, the user may be asked to provide one or more memorization items, which the user desires to remember. The user may respond by providing the one or more memorization items via an input device such as, for example, a keyboard, a microphone, or other input device. As an example, the user may be attempting to learn about various musical instruments and may provide “saxophone” as a memorization item. A user's computing device may receive the memorization item and may provide the memorization item to a server to search a library object database for an object having a name similar to that of the memorization item. In this example, the server may discover a telephone object in the library object database, which has a name, telephone, which is somewhat similar to “saxophone”. The server may provide the object to the user's computing device, which may present an image of a telephone as an object suggestion to the user. The user may accept the telephone as the object by making a gesture or via other methods, in which case a card with textual content including “saxophone” may be created and associated with the object. Otherwise, the server may send a next object that sounds somewhat like “saxophone” from the library to the user's computing device to present to the user.

Various embodiments provide support for a list of objects. In such embodiments, a user may provide as input an acronym for a list such as, for example, VRIN, which may stand for “valuable”, “rare”, “inimitable”, and “nonsubstitutable”. The user's computing device may present an image of a pumpkin because the word “pumpkin” is somewhat similar to VRIN.

After the user accepts “pumpkin” as the object by making a gesture or via other methods, the user's computing device may display a virtual room embedded within the pumpkin. The virtual room may have furniture as well as other objects within it. In some embodiments, upholstery and other aspects of the furniture may be revised by the user. The user's computing device then may search a library for respective objects that sound like or are suggestive of “valuable”, “rare”, “inimitable”, and “nonsubtitutable”. For example, the user's computing device may present an image of a raw steak, and if accepted, may place the image of the raw steak on a sofa in the embedded virtual room with an associated textual card having the word “rare” thereon. The user's computing device also may present an image of, for example, a voodoo doll, which if accepted may be placed on a bookcase with an associated textual card having the word “valuable” thereon. The user's computing device may present an image of an inkwell to represent the word “inimitable”, which if accepted by the user may be located on a desk in the embedded virtual room. The user's computing device may present an image of an unusual pendant to represent the word “nonsubstitutable”, which if accepted may be located on a table in the embedded virtual room.

After the user has selected various objects that had been placed throughout a virtual room, upon entering the room the user may be guided along a predefined path in the room such that the user walks near the objects and may select any of the objects by making a gesture or via other methods. Upon selecting an object, an associated textual card may be displayed to reveal a memorization item associated with the object. The user then may be asked whether he or she remembered the memorization item associated with the object. The user may answer with a gesture or via other methods. If the user answers in the affirmative, then the user may be assumed to have successfully memorized the memorization item. If the user answers in the negative, the user will be provided with more opportunities to select the same object at a later time.

If the user encounters an object associated with a list of objects, such as the pumpkin previously described, the user may place the object on his or her head to view a virtual room embedded within the object. In other embodiments, the user may view or enter the embedded virtual room via other methods such as, for example, touching the object (e.g., the pumpkin), or other methods. The user's computing device may direct the user along a predefined path within the embedded virtual room such that the user may select each of the objects associated with the list of objects to see an associated memorization item listed on an image of a textual card associated with the object. The user may be provided with an opportunity to indicate whether he or she remembered the memorization item. If the user did not remember the memorization item, the user may be presented with future opportunities to demonstrate that he or she has memorized the memorization item associated with the object.

In some embodiments, instead of having the user's computing device automatically place an added object at a location in a room, the user may navigate to a location in the room and indicate the location as a place for a new object via a gesture or other method.

In various embodiments, multiple libraries of objects may be stored in one or more library object databases. Each of the libraries may have objects stored therein, which may be associated with a particular subject or category. Further, in some embodiments, the user may create his or her own library of objects having a collection of objects selected from one or more other libraries of objects. Such user libraries of objects may be shared with other users in some embodiments.

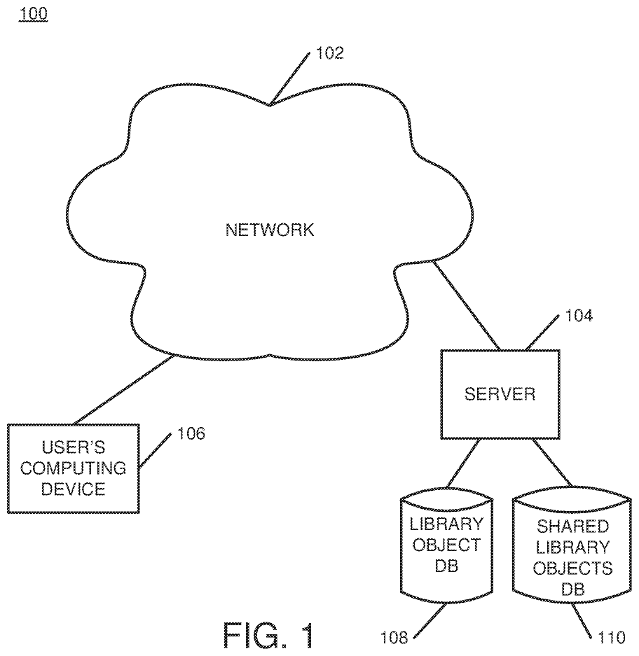

FIG. 1 shows an example environment 100 in which various embodiments may be implemented. Environment 100 may include a network 102, a server 104, a user's computing device 106, a library object database 108, and a shared libraries database 110.

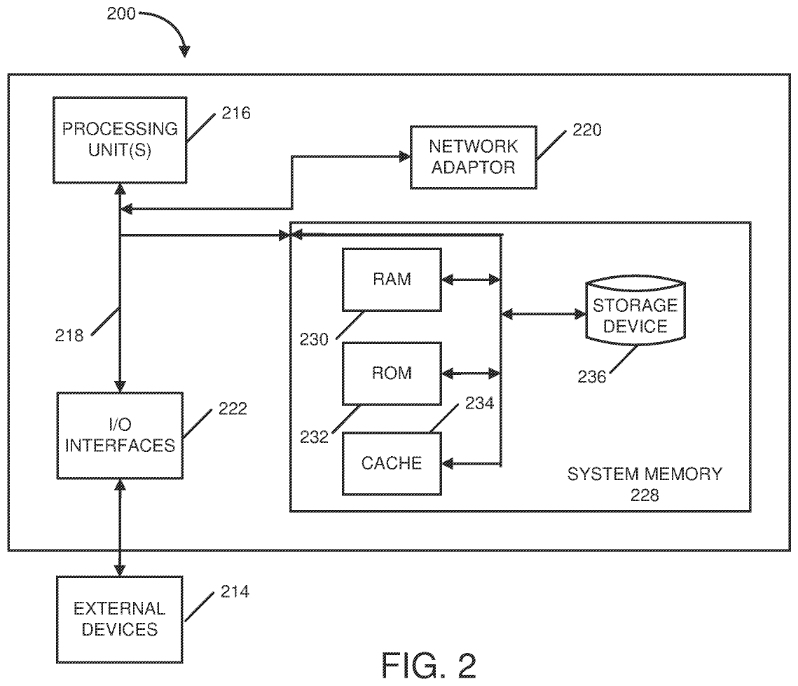

FIG. 2 illustrates a functional block diagram of an example computing device or computing system 200 that may implement user's computing device 106 and/or server 104. Computing system 200 is shown in a form of a general-purpose computing device. Components of computing system 200 may include, but are not limited to, one or more processing units 216, a system memory 228, and a bus 218 that couples various system components including system memory 228 to one or more processing units 216.

Bus 218 represents any one or more of several bus structure types, including a memory bus or memory controller, a peripheral bus, an accelerated graphics port, and a processor or local bus using any of a variety of bus architectures. Such architectures may include, but not be limited to, Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computing system 200 may include various non-transitory computer system readable media, which may be any available non-transitory media accessible by computing system 200. The computer system readable media may include volatile and non-volatile non-transitory media as well as removable and non-removable non-transitory media.

System memory 228 may include non-transitory volatile memory, such as random access memory (RAM) 230 and cache memory 234. System memory 228 also may include non- transitory non-volatile memory including, but not limited to, read-only memory (ROM) 232 and storage system 236. Storage system 236 may be provided for reading from and writing to a nonremovable, non-volatile magnetic medium, which may include a hard drive or a Secure Digital (SD) card. In addition, a magnetic disk drive, not shown, may be provided for reading from and writing to a removable, non-volatile magnetic disk such as, for example, a floppy disk, and an optical disk drive for reading from or writing to a removable non-volatile optical disk such as a CD-ROM, DVD-ROM or other optical media. Each memory device may be connected to bus 218 by at least one data media interface. System memory 228 further may include instructions for processing unit(s) 216 to configure computing system 200 to perform functions of embodiments of the invention. For example, system memory 228 also may include, but not be limited to, processor instructions for an operating system, at least one application program, other program modules, program data, and an implementation of a networking environment.

Computing system 200 may communicate with one or more external devices 214 including, but not limited to, one or more displays, a keyboard, a pointing device, a speaker, at least one device that enables a user to interact with computing system 200, and any devices including, but not limited to, a network card, a modem, etc. that enable computing system 200 to communicate with one or more other computing devices. The communication can occur via Input/Output (I/O) interfaces 222. Computing system 200 can communicate with one or more networks including, but not limited to, a local area network (LAN), a general wide area network (WAN), a packet-switched data network (PSDN) and/or a public network such as, for example, the Internet, via network adapter 220. As depicted, network adapter 220 communicates with the other components of computer system 200 via bus 218.

It should be understood that, although not shown, other hardware and/or software components could be used in conjunction with computer system 200. Examples, include, but are not limited to, microcode, device drivers, redundant processing units, external disk drive arrays, RAID systems, tape drives, and data archival storage systems, etc.

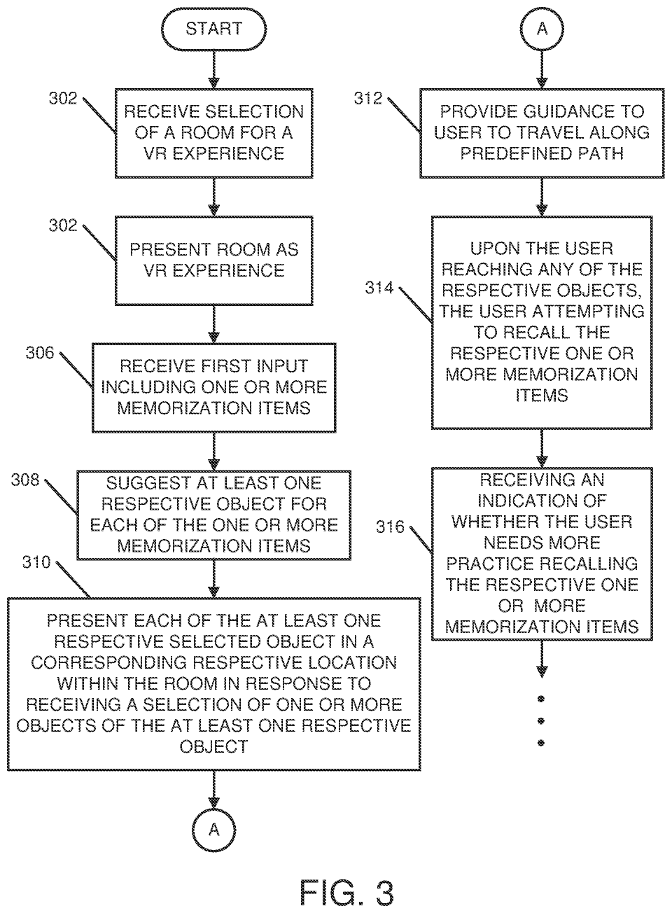

FIG. 3 is a flowchart of an example process that may be performed by user's computing device 106 working in conjunction with server 104. The process may begin with user's computing devices 106 receiving, from a user, a selection of a room for a virtual reality (VR) experience (act 302). The room may be selected from among multiple rooms that the user may select. User's computing device 104 then may present the selected room as the VR experience (act 304).

Next, user's computing device 106 may receive, from the user, first input, including one or more memorization items that the user desires to memorize (act 306). For each of the one or more memorization items, user's computing device 104 may suggest at least one respective object, which may be displayed (act 308). In response to receiving a selection of one or more objects of the at least one respective object, users computing device 106 may present each of the at least one respective selected object in a corresponding respective location within the room (act 310). Alternatively, the user may select a location within the room for each of the at least one respective selected object by navigating to a desired location within the room and indicating placement of the object at the desired location.

Upon entering the room after the objects had been placed in the various locations within the room, user's computing device 106 may provide guidance to the user to travel along a predefined path, passing near the various locations where objects are located (act 312). Upon the user reaching the locations of the respective objects within the room, the user may attempt to recall the respective one or more memorization items and may select any of the objects to view the memorization item listed on an associated textual card (act 314). The user then may be provided with an opportunity to indicate that he or she has memorized the memorization item or that he or she needs more practice regarding the memorization item (act 316). If the user indicates that he or she needs more practice, then the user may be presented with the object at a later time.

Alternatively, instead of the user indicating whether he or she has successfully memorized an association between the object and the memorization item, the user may input the memorization item, and if the provided memorization item is correct, then user's computing device 106 may treat the memorization item as having been learned. Otherwise, user's computing device 106 may treat the memorization item as having not been learned and requiring more practice.

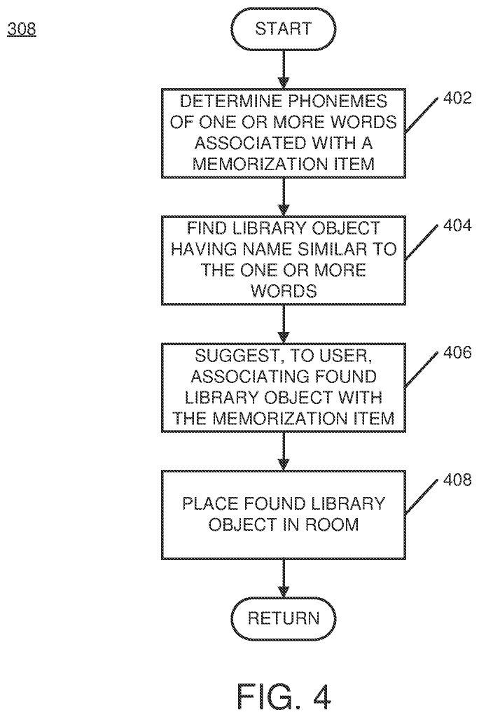

FIG. 4 is a flowchart of an example process providing more details regarding act 308 of FIG. 3. The process may begin with user's computing device 106 determining phonemes of one or more words associated with a memorization item (act 402). Next, user's computing device 106 may request server 104 to find a library object having a name similar to the one or more words based on the phonemes (act 404). Server 104 may search a current library object database 108 for library objects having a name similar to the one or more words by comparing phonemes of the name of the library object with the phonemes of the one or more words. Assuming that a library object is found, server 104 may return information regarding the found object to user's computing device 106, which may display the object at user's computing device 106 and suggest, to the user, associating the found library object with the memorization item (act 406). Assuming that the user accepts the suggestion, user's computing device 106 may place the found library object in a location within the room (act 408). Alternatively, the user may navigate to a desired location in the room and may indicate placement of the object at the desired location. The process then may be completed.

In some embodiments, instead of searching for library objects that have names similar to that of memorization items, artificial intelligence may be used to find library objects having names with a humorous association to the memorization objects. For example, the algorithm might make the connection between the vocabulary word “liquidity trap” and the object “cup”. The cup-to-liquidity trap connection would be easy to remember due to its wordplay. The algorithm would be trained on puns, wordplay and humorous literature. In one use case, the user would select one of a few options presented by the algorithm, perhaps a rhyming word or phrase along with the humorous one. The user's selection would further reinforce the algorithm. A Workflow could be for example:

A user types “liquidity trap”->algorithm returns “cup” and “gingersnap”->user chooses cup->cup selection in the algorithm data set is tagged with “humorous” or “effective”.

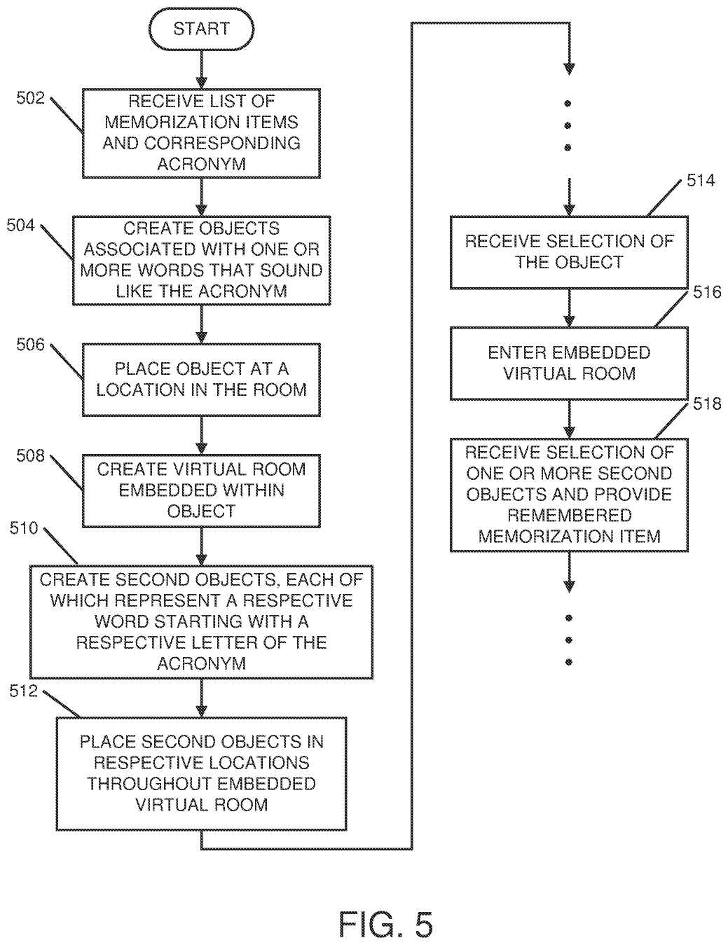

FIG. 5 is a flowchart that illustrates an example process for entering lists of memorization items associated with an object. The processor may begin by receiving a list of memorization items and a corresponding acronym as mentioned previously. For example, the list of memorization items may include a list of words such as, “valuable”, “rare”, “inimitable”, and “nonsubstitutable”. Further, the user may enter an acronym for the list of words such as, for example, “VRIN” (act 502). Because “VRIN” sounds somewhat like “pumpkin”, user's computing device 106 may find an image of a pumpkin in a current library of library object database 108, may create an image of a pumpkin in the room (act 504), and may place the image of the pumpkin at a location within the room (act 506). If the user does not accept the suggested image of the pumpkin as the object, user's computing device 106 may display an image of another object that sounds somewhat like “pumpkin” obtained from library object database 108.

Instead of user's computing device 106 selecting a location to place the object, the user may navigate to a desired location and may provide input to cause the image of the object to be displayed at the desired location in the room.

Next, user's computing device 106 may create a virtual room embedded within the object and may display the created embedded virtual room to the user (act 508). The virtual room may include furniture such as, for example, bookcases, desks, sofas, chairs, etc., as well as paintings, statues, etc. In some embodiments, the user may be able to modify the furniture, the paintings, the statues, etc.

Next, user's computing device 106 may create second objects, each of which may represent a respective word starting with a respective letter of the acronym (act 510). In some embodiments, the second objects may be displayed to the user for the user to accept. If the user chooses not to accept a second object, user's computing device 106 may display an alternative second object obtained from library object database 108.

User's computing device 106 then may place the second objects in respective locations throughout the embedded virtual room (act 512). Alternatively, the user may navigate to a desired location within the embedded virtual room for a second object and may indicate a desire to place the second object at the desired location.

At a later point in time, after objects have been placed in the embedded virtual room, the user may be guided along a predetermined path to an object corresponding to a list of objects such as, for example, the pumpkin. The user may select the pumpkin (act 514) by, for example, lifting the pumpkin and placing it on his or her head to enter and view the virtual embedded room within the pumpkin and the second objects placed therein (act 516). User's computing device 106 then may receive a selection of one or more second objects as the user is guided along the predetermined path in the embedded virtual room and may determine whether he or she remembers memorization items associated with each of the second objects (act 518).

In some embodiments, users may create their own libraries of objects. In some embodiments, the user's libraries of object may include images of objects from other libraries as well as names of those objects. Further, user's may share their libraries of objects with other users. For example, a user could share his or her library of objects with one or more specific users or with all users. Shared library objects 110 (FIG. 1) stores shared library objects as well as which users may be able to access the shared library objects and which users own the shared library objects.

In some embodiments, an assessment tool may be provided when the user performs an action or makes a gesture. In an embodiment, the assessment tool may be generated by use of a virtual tool such as, for example, a virtual laser gun or other virtual tool.

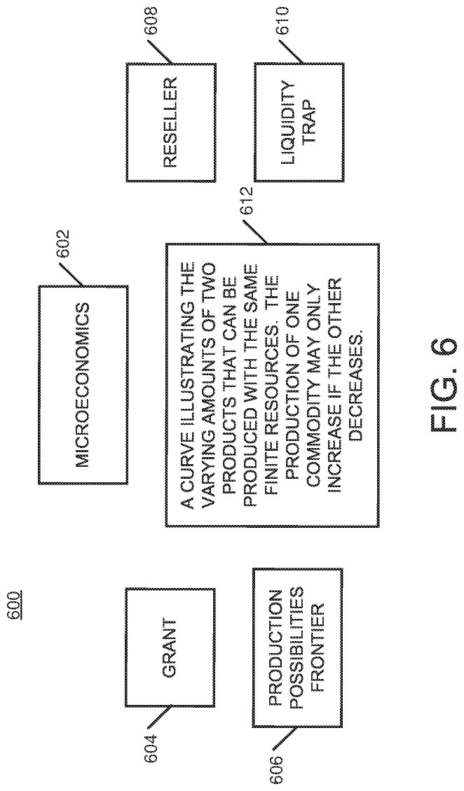

FIG. 6 shows an example assessment tool 600 that may be generated and displayed in a virtual room according to an embodiment. Assessment tool 600 may include a subject name 602 such as, for example, microeconomics or another subject name. Multiple memorization items 604-610 also may be displayed as well as a definition 612 pertaining to one of the memorization items 604-610. In some embodiments, a corresponding object (not shown) representing each of the memorization items may appear next to each of the memorization items 604-610. The user may select one of the memorization items 604-610 as being associated with definition 612 by using a virtual tool, making a gesture, or via other means. If the user selects a correct memorization item such as memorization item 606 in this example, a new definition 612 and new memorization items 604-610 may appear. If the subject changes, a new subject name 602 also may appear.

FIG. 6 shows four memorization items from which the user may select. However, other embodiments may include fewer than four memorization items or more than four memorization items from which the user may select.

After being tested on all different memorization items 604-610, a predefined number of memorization items 604-610, or upon the user indicating a desire to end the testing, user's computing device 106 may grade answers provided by the user and may display an assessment grade indicating how well the user knows subject matter of the assessment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or improvement over conventional technologies, or to enable others of ordinary skill in the art to understand the embodiments disclosed herein.

Aspects of the present invention are described herein with reference to flowchart illustrations and/or block diagrams of methods, apparatus (systems), and computer-readable storage devices having instructions stored therein for carrying out functions according to embodiments of the invention. It will be understood that each block of the flowchart illustrations and/or block diagrams, and combinations of blocks in the flowchart illustrations and/or block diagrams, can be implemented by computer readable program instructions. Each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Aspects of the present invention are described herein with reference to flowchart illustrations and/or block diagrams of methods, apparatus (systems), and computer-readable storage devices having instructions stored therein for carrying out functions according to embodiments of the invention. It will be understood that each block of the flowchart illustrations and/or block diagrams, and combinations of blocks in the flowchart illustrations and/or block diagrams, can be implemented by computer readable program instructions. Each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Aspects of the present invention are described herein with reference to flowchart illustrations and/or block diagrams of methods, apparatus (systems), and computer-readable storage devices having instructions stored therein for carrying out functions according to embodiments of the invention. It will be understood that each block of the flowchart illustrations and/or block diagrams, and combinations of blocks in the flowchart illustrations and/or block diagrams, can be implemented by computer readable program instructions. Each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

1. A method to help a user learn and remember, the method comprising:
receiving, by a computing device from the user, a selection of a room from a plurality of rooms for a virtual reality experience;
presenting, by the computing device to the user, the room as the virtual reality experience;
receiving, by the computing device, first input including one or more memorization items the user wants to memorize;
suggesting, by the computing device to the user, at least one respective object for each of the one or more memorization items; and
presenting, by the computing device to the user, each of at least one respective selected object in a corresponding respective location within the room in the virtual reality experience in response to receiving a selection of one or more objects of the at least one respective object, each of the one or more selected objects at the corresponding respective location being associated with a respective one of the one or more memorization items.

2. The method of claim 1, further comprising:
determining phonemes of one or more words associated with a memorization item of the one or more memorization items;
finding a library object having a name that is similar to the one or more words;
suggesting, to the user, associating the found library object with the memorization item; and
placing, by the computing device, the found library object in the room.

3. The method of claim 1, further comprising:
providing, by the computing device, guidance to the user to travel along a predefined path within the room;
coming upon each of the at least one respective selected object as the user travels along the predefined path, the user attempting to recall the respective one of the one or more memorization items associated with the each of the at least one respective selected object; and
receiving, by the computing device from the user, an indication of whether the user needs more practice recalling the respective one of the one or more memorization items.

4. The method of claim 1, further comprising:
adding, by the computing device, a new object to the room, the new object being associated with a memorization item of the one or more memorization items;
automatically selecting, by the computing device, a location in the room for the added new object; and
automatically placing, by the computing device, the added new object at the automatically selected location.

5. The method of claim 1, further comprising:
providing, by the computing device, support for lists, the providing support comprising:
receiving, by the computing device, an acronym representing a list of memorization items, and the list of memorization items;
creating, by the computing device, an object associated with one or more words that sound like the acronym;
placing, by the computing device, the object in a location in the room;
creating, by the computing device, a virtual room embedded within the object;
creating, by the computing device, second objects, each of the second objects representing a respective word starting with a respective letter of the acronym; and
placing, by the computing device, the second objects in respective locations throughout the embedded virtual room.

6. The method of claim 5, further comprising:
receiving a selection, by the user via the computing device, of the object associated with the one or more words that sound like the acronym;
entering, by the user via the computing device, the embedded virtual room; and
receiving a selection of one or more of the second objects to teach the user the memorization items associated with the selected one or more of the second objects.

7. The method of claim 1, further comprising:
loading, by the computing device, a library of objects of a plurality of libraries of objects, each of the plurality of libraries of objects being capable of being associated with the one or more memorization items and relating to subject matter different from subject matter of others of the plurality of libraries of objects.

8. A computing system comprising:
at least one processor;
a memory including instructions for the at least one processor;
one or more input/output devices; and
a bus connecting the memory and the one or more input/output devices with the at least one processor, wherein the instructions configure the computing system to perform operations comprising:
presenting, to the user, a room as a virtual reality experience;
receiving first input including one or more memorization items the user wants to memorize;
suggesting at least one respective object for each of the one or more memorization items; and
presenting each of at least one respective selected object in a corresponding respective location within the room in the virtual reality experience in response to receiving a selection of one or more objects of the at least one respective object, each of the one or more selected objects at the corresponding respective location being associated with a respective one of the one or more memorization items.

9. The computer system of claim 8, wherein the operations further comprise:
determining phonemes of one or more words associated with a memorization item of the one or more memorization items;
finding a library object having a name that is similar to the one or more words;
suggesting, to the user, associating the found library object with the memorization item; and
placing the found library object in the room.

10. The computer system of claim 8, wherein the operations further comprise:
using artificial intelligence to find a library object having a humorous name with an association with a memorization item of the one or more memorization items;
suggesting, to the user, associating the found library object with the memorization item; and
placing the found library object in the room.

11. The computing system of claim 8, wherein the operations further comprise:
providing guidance to the user to travel along a predefined path within the room;
coming upon each of the at least one respective selected object as the user travels along the predefined path, the user attempting to recall the respective one of the one or more memorization items associated with the each of the at least one respective selected object; and
receiving, from the user, an indication of whether the user needs more practice recalling the respective one of the one or more memorization items.

12. The computing system of claim 8, wherein the operations further comprise:
adding a new object to the room, the new object being associated with a memorization item of the one or more memorization items;
automatically selecting a location in the room for the added new object; and
automatically placing the added new object at the automatically selected location.

13. The computing device of claim 8, wherein the operations further comprise:
providing support for lists, the providing support comprising:
receiving an acronym representing a list of memorization items, and the list of memorization items;
creating an object associated with one or more words that sound like the acronym;
placing the object in a location in the room;
creating a virtual room embedded within the object;
creating second objects, each of the second objects representing a respective word starting with a respective letter of the acronym; and
placing the second objects in respective locations throughout the embedded virtual room.

14. The computing system of claim 12, wherein the operations further comprise:
receiving a selection, by the user, of the object associated with the one or more words that sound like the acronym;
entering, by the user, the embedded virtual room; and
receiving a selection of one or more of the second objects to teach the user the memorization items associated with the selected one or more of the second objects.

15. The computing system of claim 8, wherein the operations further comprise:
loading a library of objects of a plurality of libraries of objects, each of the plurality of libraries of objects being capable of being associated with the one or more memorization items and relating to subject matter different from subject matter of others of the plurality of libraries of objects.

16. A non-transitory computer-readable storage medium having instructions stored thereon for configuring a computing device to perform operations comprising:
presenting, to a user, a room as a virtual reality experience;
receiving first input including one or more memorization items the user wants to memorize;
suggesting at least one respective object for each of the one or more memorization items; and
presenting each of at least one respective selected object in a corresponding respective location within the room in the virtual reality experience in response to receiving a selection of one or more objects of the at least one respective object, each of the one or more selected objects at the corresponding respective location being associated with a respective one of the one or more memorization items.

17. The non-transitory computer-readable storage medium of claim 16, wherein the operations further comprise:
determining phonemes of one or more words associated with a memorization item of the one or more memorization items;
finding a library object having a name that is similar to the one or more words;
suggesting, to the user, associating the found library object with the memorization item; and
placing the found library object in the room.

18. The non-transitory computer-readable storage medium of claim 16, wherein the operations further comprise:
using artificial intelligence to find a library object having a humorous name with an association with a memorization item of the one or more memorization items;
suggesting, to the user, associating the found library object with the memorization item; and
placing the found library object in the room.

19. The non-transitory computer-readable storage medium of claim 16, wherein the operations further comprise:
providing guidance to the user to travel along a predefined path within the room;
coming upon each of the at least one respective selected object as the user travels along the predefined path, the user attempting to recall the respective one of the one or more memorization items associated with the each of the at least one respective selected object; and
receiving, from the user, an indication of whether the user needs more practice recalling the respective one of the one or more memorization items.

20. The non-transitory computer-readable storage medium of claim 16, wherein the operations further comprise:
adding a new object to the room, the new object being associated with a memorization item of the one or more memorization items;
automatically selecting a location in the room for the added new object; and
automatically placing the added new object at the automatically selected location.

21. The non-transitory computer-readable storage medium of claim 16, wherein the operations further comprise:
providing support for lists, the providing support comprising:
receiving an acronym representing a list of memorization items, and the list of memorization items;
creating an object associated with one or more words that sound like the acronym;
placing the object in a location in the room;
creating a virtual room embedded within the object;
creating second objects, each of the second objects representing a respective word starting with a respective letter of the acronym; and
placing the second objects in respective locations throughout the embedded virtual room.

22. The non-transitory computer-readable storage medium of claim 16, wherein the operations further comprise:
generating an assessment tool that is displayed to the user in a virtual room, the assessment tool displaying a plurality of memorization items and a definition pertaining to one of the plurality of memorization items;
receiving, from the user, a selection of one of the plurality of memorization items as pertaining to the definition;
responsive to the user selecting a correct one of the plurality of memorization items pertaining to the definition, displaying a new set of memorization items and a new definition pertaining to a memorization item of the new set of memorization items;
grading answers provided by the user during use of the assessment tool; and
presenting a grade to the user indicating performance of the user with respect to use of the assessment tool.
